(19) United States
(12) Patent Application Publication
(10) Pub. No.: US 2007/0168677 A1
(43) Pub. Date: Jul. 19, 2007

(54) Changing user authentication method by timer and the user context

(75) Inventors: Michiharu Kudo, Kamakura-shi (JP); Seiji Munetoh, Kawasaki-shi (JP); Megumi Nakamura, Yamato-shi (JP); Sachiko Yoshihama, Kawasaki-shi (JP)

Correspondence Address: Anne Vachon Dougherty, 3173 Cedar Road, Yorktown Hts, NY, 10598, US

(73) Assignee: International Business Machines Corporation, Armonk, NY (US)

(21) Appl. No.: 11/646,154

(22) Filed: Dec. 27, 2006

(30) Foreign Application Priority Data
Dec. 27, 2005 (JP) 2005-375230

(51) Int. Cl. H04L 9/00

(52) U.S. Cl. 713/185

(57) ABSTRACT

A computer system with authentication means including a storage device where first conditions, second conditions, and authentication information relating to authentication means are stored; means for acquiring the first conditions and the second conditions when a user requests authentication; and means for selecting at least one of a plurality of authentication means from the storage device based on the acquired first conditions and the second conditions.

### FIELD OF THE INVENTION

The present invention relates to minimization of a damage resulting from unauthorized access to confidential information due to leakage of authentication information as a result of using a computer in a public place.

### BACKGROUND OF THE INVENTION

With development of wireless hotspots and high-speed mobile telephone networks, and with reduction of weight and size of laptop PCs, there is an increase in opportunities to use terminal devices such as a computer and a PDA (Personal Digital Assistant) in public places such as a coffee shop, a train, an airport and the like. When a terminal device is used in a public place, there is a serious concern that confidential information could leak out to people in the area of the terminal device. In particular, it is difficult to completely prevent authentication information, such as a password, from being stolen by people observing a terminal user's fingers on a keyboard or by recording keystroke sounds. In a case where the password has been stolen, it is dangerous because there is a risk that the password may be abused for a long time after a user of the terminal device has left the location.

Particularly in recent years, cases where confidential information flows out from laptop PCs, which are misplaced or stolen, have been increasing and have become a social problem. If a start-up password for a BIOS (Basic Input/Output System) and a logon password to an OS (Operating System) are set adequately, an outflow of information by unauthorized access can usually be prevented, but such security measures are useless when authentication information such as a password has been compromised. Particularly after a terminal device such as a laptop PC has physically fallen into the hands of a third person, the terminal device cannot be reached by an original owner thereof, and the original owner is practically powerless unless any measure has been taken beforehand.

In connection with an authentication method, there have been some conventional technologies developed. In Japanese Patent Application Publication No. 2000-82044, there is disclosed a technology enabling a user to perform an authentication procedure by an old password even if a new password is forgotten after the old password has been changed to the new password. However, after the password has been stolen, this technology does not help to solve the problem of weak security. Japanese Patent Application Publication No. 2005-148952 relates to a technology where a path of access of a user is judged, and a password length is set based on the path. Although safety of security can be enhanced if a password is lengthened based on Japanese Patent Application Publication No. 2005-148952, the technology cannot be considered as an effective measure in that, after a password has been stolen, confidential information can be easily accessed. Japanese Patent Application Publication No. 2000-208993 relates to a technology where, for the convenience of a user in a case where multiple authentication methods are used for user authentication, a single authentication method is selected from a plurality of authentication means according to a situation where a user has logged out and the user has tried to log in again. Because Japanese Patent Application Publication No. 2000-208993 aims to make authentication processing simpler from the viewpoint of a user, the technology allows a third person to easily access confidential information once authentication information such as a password has leaked out.

When user authentication information has been stolen as a result of using a computer in a public place or the like, it is necessary to minimize the damage resulting from leakage of confidential information due to subsequent unauthorized access thereto.

### SUMMARY OF THE INVENTION

In order to solve the above-mentioned problem, the present invention provides an apparatus which performs user authentication. The apparatus minimizes leakage of confidential information resulting from unauthorized access thereto even when user authentication information has been stolen. The above apparatus includes: multiple authentication means; a storage device where the first conditions, the second conditions, and authentication information related to each of the multiple authentication means, are stored; means for acquiring the first conditions and the second conditions used when a user requests authentication; and means for selecting at least one of the a plurality of authentication means from the storage device based on the acquired first and second conditions. According to the present invention, even if user authentication information has been stolen as a result of using a computer in a public place, it becomes possible to prevent a third person from illegally accessing confidential information afterwards.

### BRIEF DESCRIPTION OF THE DRAWINGS

For a more complete understanding of the present invention and the advantage thereof, reference is now made to the following description taken in conjunction with the accompanying drawings.

FIG. 1 illustrates a hardware configuration whereby a system for authenticating a user operates.

FIG. 2 illustrates a hardware configuration whereby a client-side system for mainly requesting user authentication operates.

FIG. 3 illustrates a system configuration of a server and a client for performing user authentication.

FIG. 4 illustrates a system representing another embodiment in which the present invention is implemented to authenticate a user when a personal computer itself is used.

FIG. 5 illustrates contents of authentication method selection information.

FIG. 6 illustrates a flow of user authentication processing of the present invention.

### DETAILED DESCRIPTION OF THE INVENTION

Although the present invention will be described through embodiments of the invention detailed hereinbelow, the following embodiments do not limit the invention according to the scope of claims. In addition, combinations of characteristics described in the embodiments are provided for facilitating understanding of contents of the invention, and should not be interpreted as limiting.

Although a system and a method will be mainly described in the following embodiments, as obvious to those skilled in the art, the present invention can be implemented also as a software program and program product usable in a computer. Accordingly, the present invention can include an embodiment in the form of hardware, an embodiment in the form of software, and an embodiment in the form of a combination of hardware and software. The program can be stored in any computer-readable media such as a hard disk, a CD-ROM, an optical storage device or a magnetic storage device.

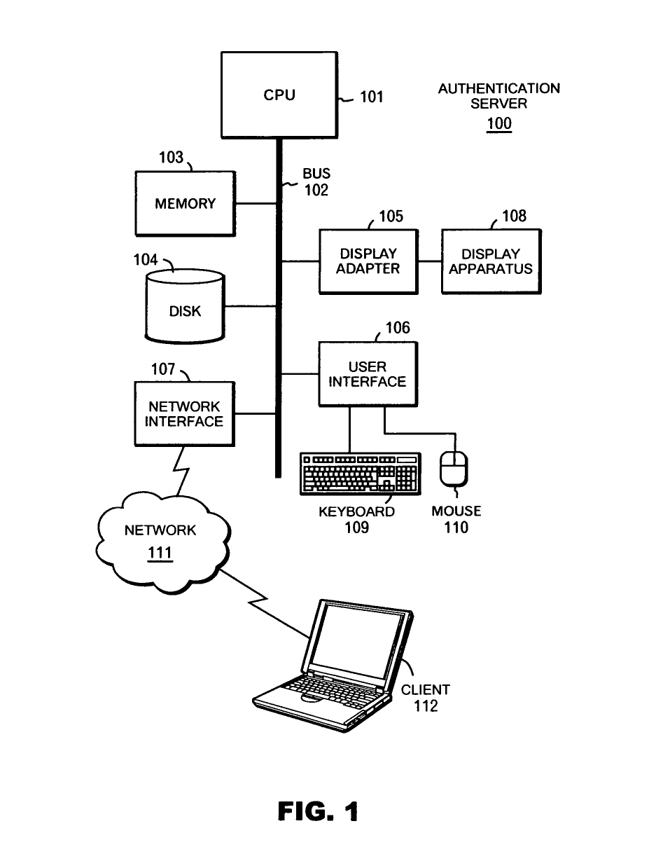

FIG. 1 shows an outline of a hardware configuration 100 whereby a system for authenticating a user operates. FIG. 1 is a server for processing an authentication request from a client computer 112 which is a user terminal device. A CPU 101 which is a central processing unit executes various programs under the control of various operating systems. The CPU 101 is mutually connected to a memory 103, a disk 104, a display adapter 105, a user interface 106 and a network interface 107 through a bus 102. The disk (a storage device) 104 includes software for causing a computer to function as a system for realizing the present invention, the operating system, and a program for executing the present invention.

The CPU 101 is connected to a keyboard 109 and a mouse 110 through the user interface 106, to a display device 108 through the display adapter 105, and to a network 111 through the network interface 107. When the present invention is carried out in a distributed environment, the network interface 107 and the network 111 become necessary. In addition, through the network 111, the CPU 101 receives authentication information from the user terminal device 112. Note that this hardware configuration 100 is only an example of one embodiment of a computer system, a bus arrangement and a network connection. Characteristics of the present invention can also be realized even in an embodiment formed of various system configurations each including multiple identical constituent elements or in an embodiment where the various system configurations are further distributed on a network.

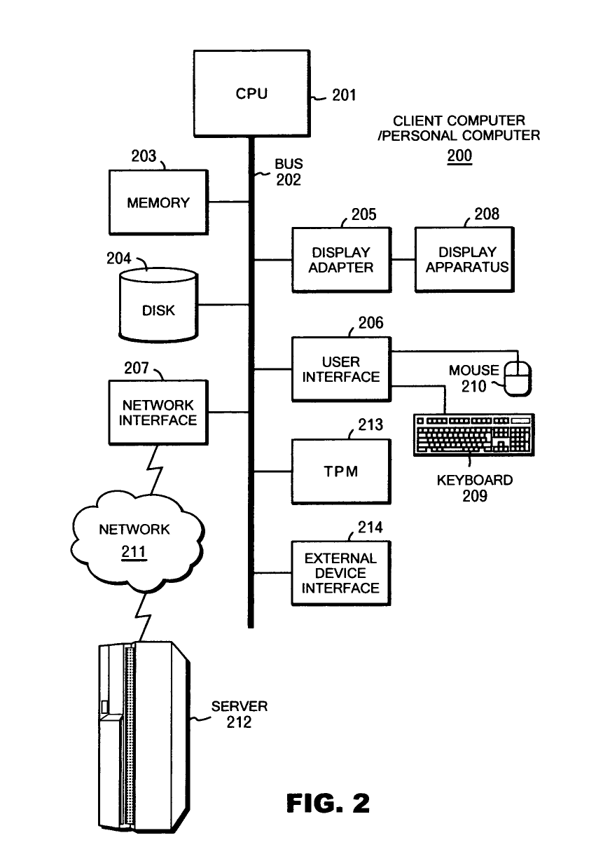

FIG. 2 shows an outline of a hardware configuration 200 whereby a client-side system mainly for requesting user authentication operates. Basic functions provided by the client-side system are substantially similar to those of FIG. 1. Note that the client-side system is connected to an authentication server 212 through a network 211. Further, the authentication process can be performed inside the client for permitting use of the client computer itself, for example, for authentication processing at power-on or at logon to the OS. Moreover, although it is not essential, a TPM (Trusted Platform Module) chip 213 can be used in order to improve reliability of authentication information. Furthermore, the client-side system may be equipped with an external device interface 214 to use a security token such as a USB key, an IC card such as a smart card, and biometric information as an authentication method.

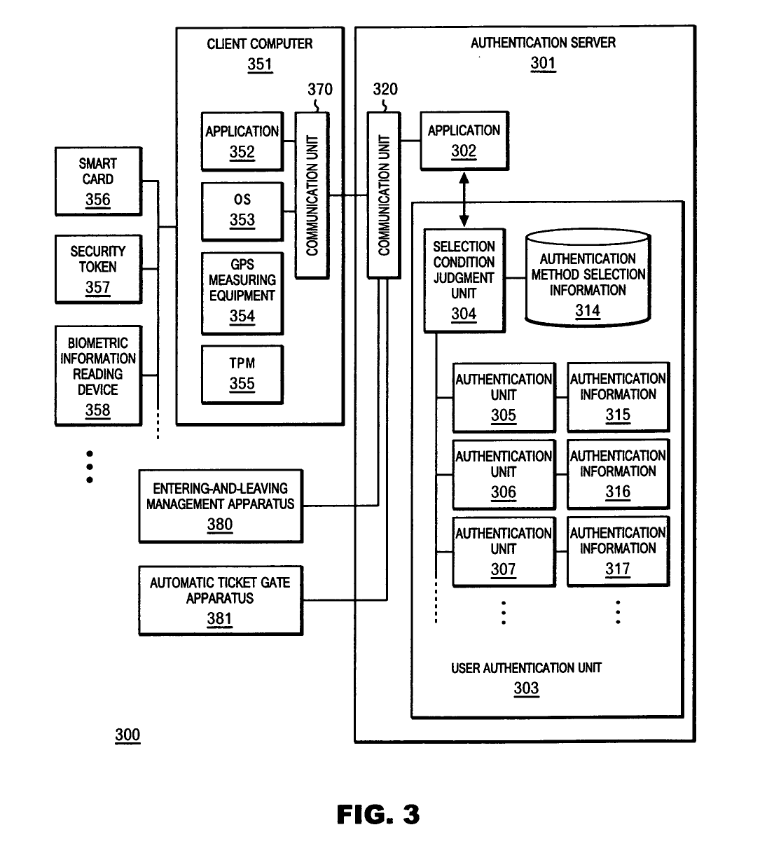

FIG. 3 shows an outline of a system configuration 300 of an authentication server 301 and a client computer 351 for performing user authentication. Inside an application 302 of the authentication server, an authentication request issued by an application 352 of the client computer or an OS 353 through a communications unit 370 is acquired through a communications unit 320, and is passed to a user authentication unit 303. Based on a state where a user requests access, a selection condition judgment selection 304 judges which authentication method should be selected. Conditions regarding which authentication method should be selected are judged based on authentication method selection information 314 stored in the storage device. In the authentication method selection information 314, the conditions are set as, for example, a time condition (the first condition) such as a time frame when a user makes an access, and a location condition (the second condition) which is the type of networks accessed by the client computer. The details for these conditions will be described later.

Then, at least one user authentication method is selected based on those conditions. Depending on the authentication method selected by the selection condition judgment unit 304, user authentication is performed by any one of authentication units 305 to 307 and so on. Authentication units 305 to 307 and so on, store authentication information 315 to 317 and so on for authenticating a user. The authentication units 305 to 307 include authentication units which respectively execute, for example, an authentication method using a user ID and a password, an authentication method using a one-time password, an authentication method using an IC card, an authentication method using a security token, an authentication method using biometrics, an authentication method using a question and an answer thereto which utilize knowledge such as a name of a pet a birthday of the user, or the like. Furthermore, any conceivable authentication method other than the above methods may be included.

GPS measuring equipment 354 is included in the client computer 351, and transmits positional information of the user to the authentication server when need arises. Additionally, the positional information of the user may be obtained from an entering-and-leaving management apparatus 380 for a security area, or from passage information of an automatic ticket gate apparatus 381 at a station. In a case where a TPM chip 355 is included in the client computer, a hardware configuration and a software configuration of the terminal device can be measured and reported, whereby highly reliable authentication is enabled if the TPM chip 355 is used for authentication in the authentication server 301. Furthermore, there is a case where an IC card 356, a security token 357, a biometric information reading device 358 or the like is included. The client computer 351 is provided with equipment needed to obtain authentication information used for authenticating a user in the user authentication server 301.

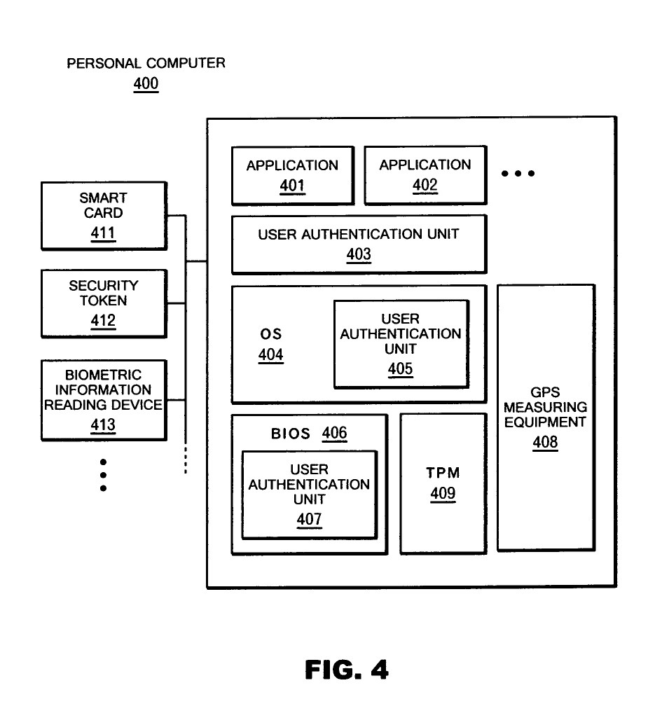

FIG. 4 shows a system 400 indicating another embodiment in which the present invention is carried out in order to authenticate a user when a personal computer itself is used. Various applications 401, 402 and the like, judge whether or not use of the application should be allowed, by authenticating a user with a user authentication unit 403. An OS 404 authenticates a user by a user authentication unit 405 when a user logs on. Additionally, in a BIOS 406, a user authentication unit 407 authenticates a user at start-up of the personal computer. Furthermore, it may be that a TPM chip 409, an IC card 411, a security token 412, a biometric information reading device 413 or the like, which is used for the user authentication, is included in the personal computer. Note that a detailed description on the authentication units 403, 405 and 407 is omitted here because each of these user authentication units has functions similar to those of the user authentication unit 303 of FIG. 3. Note that the user authentication units 403, 405 and 407 may be provided as one user authentication unit so as to have common functions thereof incorporated in one unit. Note that authentication information is mainly inputted through a user interface (reference numeral 106 in FIG. 1 or the like) in the case of FIG. 4.

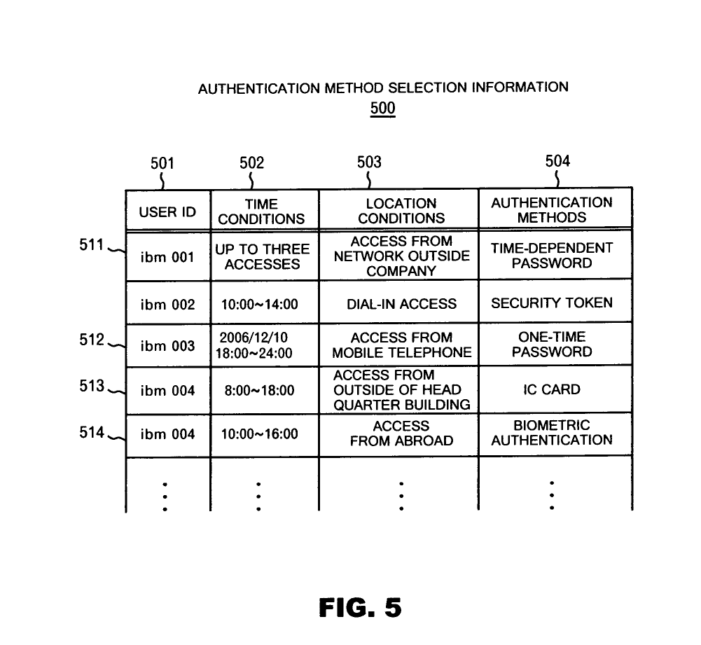

FIG. 5 exemplifies contents of authentication method selection information 500 of FIG. 3. Reference numeral 501 denotes user IDs. Because authentication methods are managed on a user-to-user basis, plural authentication methods may be required for one user depending on selection conditions therefor, and hence there is a case where there are multiple records for the same user ID. Reference numeral 502 denotes time conditions. In addition to a time frame during which a user requests authentication, the time conditions 502 may also be the number of accesses as in the case with a record 511. In addition, as in the case with a record 512, a specific day and a time frame, instead of only a time frame, may be designated as the condition. In addition or otherwise, either of a specific day of the week, and a time frame may be designated as the condition. Reference numeral 503 denotes location conditions each regarding a location where each user is. For example, as the location conditions 503, a logical location which is a kind of network through which a user attempts to request authentication, a geographical location (a physical location) where any unspecified person may be present around the user, and the like can each be set. The kind of network can be specified by using an IP address and the like, and a location where a user is can be grasped by position measured by a GPS measuring equipment, check on entering and leaving a high security area, passage of a ticket gate at a station, and the like.

Reference numeral 504 denotes authentication methods. If one of the authentication methods agrees with any one of combinations of the time conditions 502 and the location conditions 503, multiple authentication methods can be selected for one user. For example, when a user having an User ID “ibm004” has made an access from abroad during a time period from 10:00 to 16:00, the access falls under both record 513 and a record 514, and therefore, the user must authenticate himself by both an IC card and biometrics. In addition, in a case where there is no record matched with the access with respect to the user IDs 501, the time conditions 502 and the location conditions 503, a default authentication method may be selected, or the access by the user may be denied by refusing the authentication.

A record can be automatically deleted in a case where, with the passage of time, the time condition 502 therefor has come to have no possibility of being used in the future on a day. Although the authentication method selection information is shown by taking a data configuration of FIG. 5 as an example for the purpose of facilitating understanding thereof, items in a database can be normalized and expressed in different forms, and it is obvious to those skilled in the art that the items can be configured in various forms. The authentication method selection information 500 can be configured to be used in the authentication units 403, 405 and 407 of FIG. 4. In a case where the information is used in FIG. 4, there are some items for which the user IDs and the location conditions are not required when the information is a power-on password.

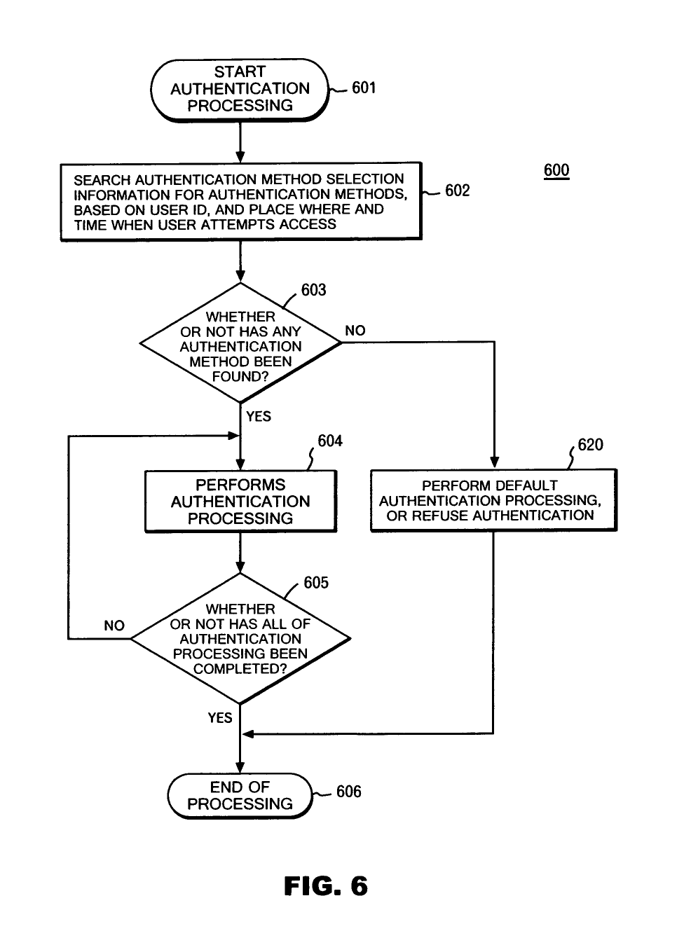

FIG. 6 exemplifies a flow of user authentication processing of the present invention. The authentication processing is started in Step 601. In Step 601, an authentication request is transmitted to an authentication server by the client computer. Incidentally, in the case of the personal computer of FIG. 4, turning-on of a power switch, logon to the OS or start-up of an application are cited as examples. In Step 602, the authentication method selection information is searched for any applicable authentication methods, based on a user ID, a place where a user attempts access (a location condition), and a time when an authentication request has been started (a time condition). The user ID may be one having been recoded previously in the client computer, and automatically transmitted, or may be configured to be inputted by a user each time and transmitted. The time when the authentication request is started may be acquired in a manner that the time is included in the authentication request, or may be acquired from an internal clock each time. In the case of the personal computer of FIG. 4, the user ID is not necessarily required. In Step 603, it is judged whether or not any authentication method has been found as a result of the search in Step 602.

If any authentication method has been found in Step 603 (Yes), the processing advances to Step 604. In Step 604, authentication processing with respect to the user is performed by the authentication method found by the search in Step 602. In Step 604, for example, the user is required to input necessary information. The user is required to input, for example, a one-time password, biometric information, or secret information that only the user can know. It is judged in Step 605 whether or not authentication processing for all of the selected authentication methods has been completed. Step 605 assumes the case where multiple methods have been found by the search. If it has been judged in Step 605 that the authentication processing for all of the authentication methods has not been completed (No), the processing returns to Step 604, where uncompleted authentication processing is performed. On the other hand, if it has been judged in Step 605 that all of authentication processing has been completed (Yes), the processing advances to Step 606, where the processing is ended.

If no authentication method has been found in Step 603 from the authentication method selection information (No), the processing advances to Step 620. In Step 620, the user may be authenticated by the default authentication method, or the authentication may be refused. Thereafter, the processing is ends in Step 606.

When a user takes a PC to visit premises of a customer, safety is enhanced according to the hereinabove described present invention if, during a time frame when the user is out, a regular authentication method is configured to be used in a case where the PC is connected to a server from a network of the customer company, and a one-time password valid only for a certain time period is configured to be used, for example, in transit. This is because the one-time password becomes invalid with the passage of time even if the one-time password has been stolen when the user is in transit, and furthermore, authentication can be refused if access is attempted from a network or a geographical location that are unexpected.

In addition, a risk that confidential information in the PC leaks out is considerably reduced if, during a time frame when the user is out, a power-on password or a password for logon to an OS can be set as those different from regular passwords. This is because, even if the one-time password has been sneaked a glance at, and additionally, a PC has been stolen at the time when the user is out, passwords for using the PC are changed with a change of places and with the passage of time.

Although the present invention has been described hereinabove by using the embodiments, a technical scope of the present invention is not limited to the scope described in the above embodiments. It is obvious to those skilled in the art that various changes or modifications can be added to the above embodiments. It is obvious from descriptions in the scope of claims that embodiments where such changes or modifications are added to the above embodiments can also be included in a technical scope of the present invention.

Although the preferred embodiments of the present invention has been described in detail, it should be understood that various changes, substitutions and alternations can be made therein without departing from spirit and scope of the inventions as defined by the appended claims.

What is claimed is:

1. An apparatus comprising:
a plurality of authentication means;
a storage device in which first conditions and second conditions for the multiple authentication means, and authentication information relating to each of the multiple authentication means are stored;
means for acquiring the first and second conditions if a user requests authentication; and
means for selecting at least one of the a plurality of authentication means from the aforementioned storage device based on the acquired first and second conditions.

2. The apparatus according to claim 1, wherein the first conditions are time conditions.

3. The apparatus according to claim 1, wherein the second conditions are location conditions.

4. The apparatus according to claim 1, wherein the a plurality of authentication means comprise at least one of authentication means using a user ID and a password, authentication means using a one-time password, authentication means using a security token, authentication means using biometrics, authentication means using an IC card, and authentication means using a TPM chip.

5. The apparatus according to claim 2, wherein the time conditions comprise at least one of the number of accesses, specification of a certain time period, certain times of a day, and a day of the week.

6. The apparatus according to claim 3, wherein the location conditions comprise at least one of a physical location where the user is, and a logical location including a kind of network that the user attempts to access.

7. The apparatus according to claim 1, further comprising a communications unit, wherein the means for acquiring the second conditions is implemented through the communications unit.

8. The apparatus according to claim 1, further comprising a user interface, wherein the means for acquiring the second conditions is performed through the user interface.

9. A computer implemented authentication method comprising the steps of:
acquiring an authentication request including first conditions and second conditions to be used if a user requests authentication; and
selecting at least one of a plurality of authentication means, from the storage device where authentication information relating to each of the plurality of authentication means are stored, based on the acquired first and second conditions.

10. The method according to claim 9, wherein the first conditions are time conditions.

11. The method according to claim 9, wherein the second conditions are location conditions.

12. The method according to claim 9, wherein the a plurality of authentication means comprise at least one of authentication means using an user ID and a password, authentication means using a one-time password, authentication means using a security token, authentication means using biometrics, authentication means using an IC card, and authentication means using a TPM chip.

13. The method according to claim 10, wherein the time conditions comprise at least one of the number of accesses, specification of a certain time period, certain times of a day, and a day of the week.

14. The apparatus according to claim 11, wherein the location conditions comprise at least one of a physical location where the user is, and a logical location including a kind of network that the user attempts to access.

15. A computer program product for causing a computer to execute a method for dynamic user authentication, said method comprising the steps of:
acquiring an authentication request including first conditions and second conditions to be used if a user requests authentication; and
selecting at least one of a plurality of authentication means, from the storage device where authentication information relating to each of the plurality of authentication means are stored, based on the acquired first and second conditions.
